(19) United States
(12) Patent Application Publication
(10) Pub. No.: US 2023/0371709 A1
(43) Pub. Date: Nov. 23, 2023

(54) BODY SUPPORTING SYSTEM WITH ADJUSTABLE FIRMNESS AND RELATED METHOD

(71) Applicant: Raja Singh Tuli, Montreal (CA)

(72) Inventor: Raja Singh Tuli, Montreal (CA)

(21) Appl. No.: 18/197,931

(22) Filed: May 16, 2023

Related U.S. Application Data
(60) Provisional application No. 63/342,705, filed on May 17, 2022.

(51) Int. Cl. A47C 31/12; A47C 31/00

(52) U.S. Cl. CPC A47C 31/123; A47C 31/003

(57) ABSTRACT

A body supporting device system is provided comprising: a body supporting device configured to support at least part of a body; a pressure sensing layer comprising a plurality of pressure sensors arranged in a sensor pattern, the plurality of pressure sensors being each configured to sense pressure on the surface of the body supporting device at a corresponding sensing location; and a firmness adjusting layer comprising a plurality of actuators arranged in an actuator pattern, the plurality of actuators are each configured to control the firmness of the surface of the body supporting device at a corresponding adjusting location based on some or all of the pressures sensed by the plurality of pressure sensors

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present disclosure in general relates to body supporting systems and devices such as mattress, chair, car seat, etc., and their operating and manufacturing methods, and in particular to body supporting systems and devices with adjustable firmness, and related operating and manufacturing methods.

### Description of Related Art

Body supporting devices and systems such as mattress are employed to support at least part of a body e.g. a human body. As an example, a mattress is used for a user to sleep on and thus is configured to support the user's body when the user is sleeping on the mattress. In addition to mattress, there are numerous other types of body supporting devices and systems such as e.g. chairs, car seats, chair cushions, and etc. It is to be understood that the list of body supporting devices and systems identified above is not exhaustive and that these and other body supporting devices and systems can be used with the present disclosure and are within the scope of the present disclosure. It is also to be understood that a reference in this specification to any one such device or system, such as a “mattress” is to be taken to be a reference to any and all other suitable body supporting devices and systems including chairs, car seats and the like.

By way of example, with a user lying or sitting on, a mattress provides a support to counteract the weight or part of the weight of the user. In particular, the mattress distributes the weight from the body of the user over a part of the surface of the mattress. Depending on how a mattress distributes the weight of the user and/or how much support a mattress provides, the mattress will be either soft or firm. The firmness of a mattress depends on e.g. the properties of the resilient or elastic elements in the mattress, such as the spring constant, and how the resilient or elastic elements are mounted in the mattress, such as the degree of clamping or pre-tensioning. Consequently, the firmness of a mattress is normally configured and/or set during its manufacturing. Similarly, the same applies to other body supporting devices and systems.

It is understood that, the perception and preference to firmness vary from one person to another. Also it is understood that different body parts of a user who is lying or sitting or leaning on a body supporting device or system may require different support from the body supporting device or system and thus require different firmness. Further in consideration of the potential movement of a user on a body supporting device or system e.g. during sleep or sitting or leaning, it is desirable for an adjustable firmness of the body supporting device or system, in order for an optimal support and an optimal user experience,

Therefore, a need exists for body supporting devices and systems with adjustable firmness, and their operating and manufacturing methods.

### BRIEF SUMMARY OF THE INVENTION

Embodiments are presented herein of, inter alia, a body supporting system with adjustable firmness.

In an embodiment of the present disclosure, a body supporting system is provided comprising: a body supporting device configured to support at least part of a body; a pressure sensing layer comprising a plurality of pressure sensors arranged in a sensor pattern; and a firmness adjusting layer comprising a plurality of actuators arranged in an actuator pattern. The plurality of pressure sensors are each configured to sense pressure on the surface of the body supporting device at a corresponding sensing location and the plurality of actuators are each configured to control or adjust the firmness of the surface of the body supporting device at a corresponding adjusting location based on some or all of the pressures sensed by the plurality of pressure sensors.

### BRIEF DESCRIPTION OF THE DRAWINGS

The various preferred embodiments of the present invention described herein can be better understood by those skilled in the art when the following detailed description is read with reference to the accompanying drawings. The components in the figures are not necessarily drawn to scale and any reference numeral identifying an element in one drawing will represent the same element throughout the drawings. The figures of the drawing are briefly described as follows.

FIG. 1 schematically illustrates a mattress system comprising a mattress and an associated firmness sensing and adjusting layer placed underneath the mattress, according to an embodiment of the present disclosure;

FIG. 2 schematically illustrates a plan view of a portion of a firmness sensing and adjusting layer, according to an embodiment of the present disclosure;

FIG. 3 schematically illustrates a plan view of a portion of the surface of an associated mattress corresponding to the portion of the firmness sensing and adjusting layer as illustrated in FIG. 2, according to an embodiment of the present disclosure;

FIG. 4 schematically depicts a user lying on a mattress that sags at some locations under high pressure, according to an embodiment of the present disclosure;

FIG. 5 schematically depicts a user lying on a mattress with her/his spine being pushed upwards at her/his hip.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE INVENTION

As an example of a body supporting device, a mattress is filled with resilient or elastic material such as foam, rubber, or an arrangement of coiled springs, and is used for the user to lie or sleep on. It is to be understood that a reference in this specification to a mattress is to be taken to be a reference to any and all possible appropriate types of body supporting devices or systems, and a reference in this specification to any type of mattress such as foam mattress is to be taken to be a reference to any and all possible appropriate types of mattress.

When a user sleeps or sits on a mattress, the weight of the user applies a pressure over a part (an area) of the surface of the mattress, and therefore requires a support from the mattress.

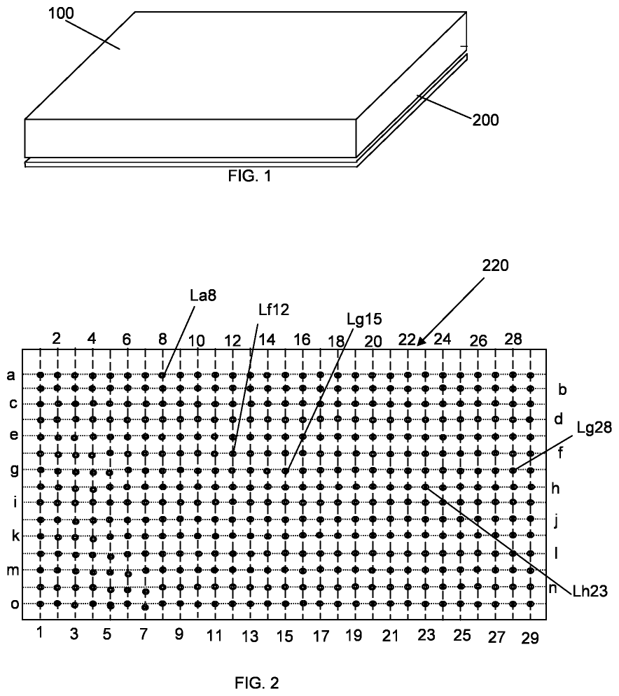

According to an embodiment of the present disclosure, a firmness sensing and adjusting layer may be provided in association with a body supporting device such as mattress, the firmness sensing and adjusting layer containing a plurality of pressure sensors and a plurality of actuators both arranged in and preferably throughout plane(s) parallel to the body supporting device's surface. By way of example, FIG. 1 schematically illustrates a mattress system comprising a mattress 100 and an associated firmness sensing and adjusting layer 200 placed underneath the mattress 100, according to an embodiment of the present disclosure.

It is appreciated that, a firmness sensing and adjusting layer may be placed underneath, on top of, or in the middle of an associated body supporting device such as mattress, or even may be embedded in an associated body supporting device such as mattress. Also, it is appreciated that a firmness sensing and adjusting layer may be constituted of two individual layers, one for firmness sensing while the other for firmness adjusting.

By way of example, FIG. 2 schematically illustrates a plan view of a portion of a firmness sensing and adjusting layer (e.g. 200 as illustrated in FIG. 1), according to an embodiment of the present disclosure. In FIG. 2 a 15*29 matrix 220 is illustrated on the plan view of the portion of the layer (e.g. 200), with in total 435 locations provided on the plane of portion of the layer (e.g. 200). It is to be noted that only several locations (rather than all locations) are indicated with reference numbers in FIG. 2, e.g. La8, Lf12, Lg15, Lg28, and Lh23.

According to an embodiment of the present disclosure, a pair of a pressure sensor and an actuator is provided at each location in the matrix 220. In such way, a 15*29 matrix 220 of pairs of pressure sensor and actuator is provided in the portion of the layer (e.g. 200) as illustrated in FIG. 2.

It is to be appreciated that, the number of rows and of columns in the matrix 220 as illustrated in FIG. 2 and thus the number of locations and of pressure sensors/actuators are only for the purpose of illustration, and any number can instead be used as needed. It is also to be appreciated that the pressure sensors and the actuators being arranged in a matrix as illustrated in FIG. 2 are only for the purpose of illustration, and in practice the pressure sensors and the actuators may be arranged in any appropriate configurations or pattern. Further it is to be appreciated that the pressure sensors and the actuators may be provided only in some selected area(s) in the plane of a firmness sensing and adjusting layer, rather than throughout the plane of the layer, and the pressure sensors and the actuators may be arranged in different planes or even in separate layers.

As an example, a firmness sensing and adjusting layer may be provided with 10,000 pressure sensors and 10,000 actuators both arranged in a 100*100 matrix throughout the plane of the layer. In this example configuration a 100*100 matrix of in total 10,000 locations is mapped in the plane of the layer, where at each of these locations a pressure sensor and an actuator are provided, thereby providing in total 10,000 pressure sensors and 10,000 actuators in the plane of the layer arranged in the 100*100 matrix.

It is to be appreciated that a pressure sensor and an actuator may be provided at a location in any appropriate manner. As an example, a pressure sensor and an actuator may be provided side by side at a location.

It shall be understood that the embodiment as described above e.g. in reference to FIG. 2 is only for the purpose of illustration and acts as a exemplary implementation where the plurality of pressure sensors and the plurality of actuators are arranged in a roughly same pattern e.g. matrix, that is, they are located in pair in roughly a same location, i.e. a pair of one of the pressure sensors and one of the actuators are located in a roughly same location. However, it is appreciated that the number and/or the arrangement (e.g. the pattern and the plane) of the pressure sensors may be different from that of the actuators. As an example, there may exist 2,000 actuators and 1,000 pressure sensors arranged in a firmness sensing and adjusting layer, either in a same pattern (e.g. matrix) or in (e.g. two) different patterns e.g. matrix, and potentially even in (e.g. two) different planes or in separate layers, according to an embodiment of the present disclosure.

The pressure sensor provided at each location of its matrix is configured to sense the pressure applied at the corresponding location on the surface of the associated body supporting device such as mattress. That is, a same or similar matrix is mapped on the surface of the associated body supporting device such as mattress (e.g. 100 as illustrated in FIG. 1), with locations one-to-one corresponding to the locations (e.g. La8, Ld12, Lf18) of the matrix (e.g. 220 as illustrated in FIG. 2) of the pressure sensors on the firmness sensing and adjusting layer (e.g. 200 as illustrated in FIG. 1).

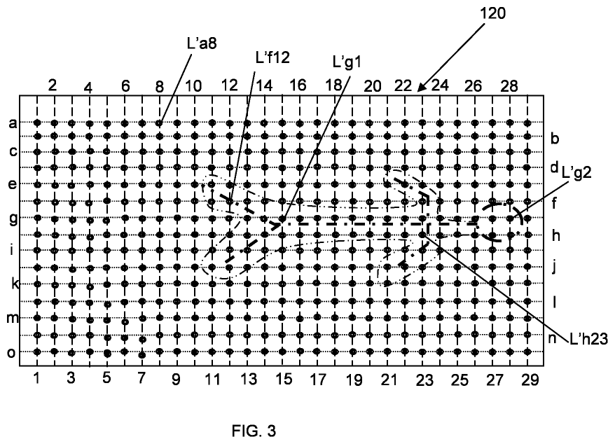

FIG. 3 schematically illustrates a plan view of a portion of the surface of a body supporting device such as mattress (e.g. 100 as illustrated in FIG. 1) corresponding to the portion of the firmness sensing and adjusting layer (e.g. 200 as illustrated in FIG. 1) as illustrated in FIG. 2, according to an embodiment of the present disclosure. As illustrated in FIG. 3 a 15*29 matrix 120 is mapped on the portion of the surface of the body supporting device such as mattress (e.g. 100), with in total 435 locations (e.g. L′a8, L′f12, L′g15, etc.) one-to-one corresponding to the 435 locations (e.g. La8, Lf12, Lg15, etc.) on the firmness sensing and adjusting layer as illustrated in FIG. 2. In particular, locations L′a8, L′f12, L′g15, L′g28, and L′h23 are indicated in FIG. 3, corresponding to locations La8, Lf12, Lg15, Lg28, and Lh23 as illustrated in FIG. 2 respectively.

In the example as illustrated in FIGS. 2 and 3, the sensor provided at location Lg28 in the firmness sensing and adjusting layer (e.g. 200) is configured to sense the pressure at location L′g28 on the surface of the associated body supporting device such as mattress (e.g. 100), and similarly the sensors at e.g. locations La8, Lf12, Lg15, and Lh23 are configured to sense the pressure at locations L′a8, L′f12, L′g15, and L′h23 respectively. In a similar way, all sensors provided in a firmness sensing and adjusting layer (e.g. 200) sense the pressures at corresponding locations on the surface of an associated body supporting device such as mattress (e.g. 100), generating a pressure map on the surface of the body supporting device such as mattress.

In such way, with the pressure sensors provided in a firmness sensing and adjusting layer (e.g. 200) and arranged in a pattern (a sensor pattern e.g. matrix such as 220), a pressure map of a user lying or sitting or leaning on an associated body supporting device such as mattress (e.g. 100) may be sensed or determined. By way of example, also in FIG. 3 a user is schematically illustrated as lying on a mattress (e.g. 100 as illustrated in FIG. 1), in which a pressure map or individual pressures at individual localized locations on the mattress's surface is determined by the sensors provided in the associated firmness sensing and adjusting layer (e.g. 200).

It is understood that, when a user is lying or sitting on a mattress, a high pressure may be sensed in the area of the mattress's surface where the user is lying or sitting on, while a minimal or even no pressure may be sensed outside the area where the user is lying or sitting on. It is also understood that even in the area where the user is lying or sitting on, the pressures sensed by the pressure sensors vary from one location to another. As an example, at the location where the user's shoulder touches the mattress, a high pressure is sensed, while at the location where the user's hip touches the mattress, an even higher pressure is sensed, and the mattress sags at some locations under such high pressure.

Referring back to FIG. 3, based on the pressure map or some or all of the individual pressures at individual localized locations on the surface of the body supporting device such as mattress sensed by the pressure sensors, it is possible to determine or deduce the locations and/or postures of the body parts of the user lying or sitting or leaning on the body supporting device such as mattress. By way of example, it may be determined in the example as illustrated in FIG. 3 that the user is lying on her/his back on the mattress, and the location L′g28 corresponds to the head of the user, the location L′h23 corresponds to the left shoulder of the user, the location L′g15 corresponds to the user's hip, while the location L′f12 corresponds to the right leg of the user.

As mentioned above, in the pattern (sensor pattern, e.g. matrix) of the pressure sensors or in another pattern (e.g. matrix), and in particular at each location in the respective pattern, an actuator is also provided in the firmness sensing and adjusting layer, e.g. pairing with the respective pressure sensor provided at the same location when the number and the pattern of the pressure sensors and the actuators are the same. The actuators provided in the firmness sensing and adjusting layer are each configured to operate based on some or all of the pressures sensed by the pressure sensors provided in the firmness sensing and adjusting layer, in order to control (e.g. maintain or change such as increase or decrease) the firmness of the associated body supporting device such as mattress at the corresponding location, whereby providing a body supporting device with adjustable firmness.

As an example, all pressures sensed by the pressure sensors provided in a firmness sensing and adjusting layer are transmitted to a control unit such as microcontroller unit e.g. provided on the side of an associated body supporting device, which determines, e.g. by using an algorithm, the desired operations/behaviors for some or all actuators provided in the firmness sensing and adjusting layer based on some or all of the pressures and then sends the corresponding instructions to the corresponding actuators to operate accordingly. It is to be appreciated that in some embodiments or scenarios only the actuators in certain area(s) of the layer, rather than all actuators in the layer, need to be operated based on the instructions from the microcontroller unit.

Referring back to FIGS. 2 and 3, a pair of a pressure sensor and an actuator is provided at each location of the matrix 220, in an example embodiment of the present disclosure. As an example, in the firmness sensing and adjusting layer at the location Lf12 a pressure sensor Sf12 that is configured to sense the pressure on the body supporting device such as mattress at location L′f12 and an actuator Af12 that is configured to control the firmness of the body supporting device such as mattress at location L′f12 are provided. Similarly, a pair of pressure sensor and an actuator is provided at each of the other locations in the matrix 220. In this way, with the pressure sensors and the actuators provided in a firmness sensing and adjusting layer it is possible to control e.g. maintain or change the firmness of an associated body supporting device such as mattress at a substantial number of localized locations, thereby providing a more flexible control or adjustment of the firmness of the body supporting device such as mattress and improving the user experience.

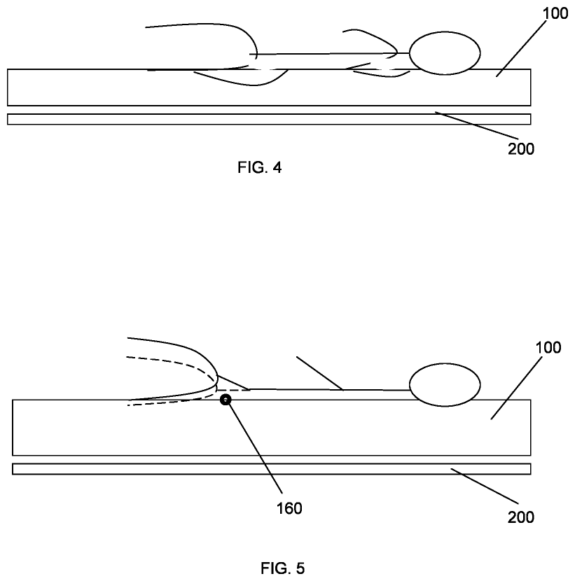

By way of example, FIG. 4 schematically depicts a user lying on a mattress that sags at some locations under pressure, according to an embodiment of the present disclosure. As illustrated in FIG. 4, a firmness sensing and adjusting layer 200 is placed underneath a mattress 100, on which a user is lying on. It is understood that, because of high pressure applied by the head, shoulder and hip of the user, the mattress sags at the corresponding locations and consequently the body of the user is not on an even plane, as schematically depicted in FIG. 4.

In an embodiment of the present disclosure, a firmness sensing and adjusting layer may be configured to equalize the pressure applied by the user lying on an associated body supporting device such as mattress or the supporting force from the body supporting device. As an example, when a user lies e.g. on her/his side on a mattress e.g. as shown in FIG. 4, the pressure sensors provided in a matrix e.g. 220 in an associated firmness sensing and adjusting layer e.g. 200 can obtain a pressure map of the user on the mattress e.g. 100 by sensing the pressures at all the corresponding locations (e.g. the matrix 120 as illustrated in FIG. 3) on the mattress's surface.

By way of example, a higher pressure is detected at the location on the mattress's surface where the user's e.g. hip and shoulder and head touches the surface of the mattress in comparison to other locations. Based on the pressure map or some or all of the individual pressures at individual localized locations as sensed, the actuators provided in the firmness sensing and adjusting layer e.g. 200 in e.g. the same matrix operate accordingly. As an example, in comparison to other locations on the mattress's surface, the actuators provided at the locations (e.g. Lg15, Lg28, and Lh23 as illustrated in FIG. 2) of the pressure sensors that sensed a higher pressure operates to decrease the firmness of the associated mattress at the corresponding locations (e.g. L′g15, L′g28, and L′h23 as illustrated in FIG. 3), in order to equalize the pressure.

As an example, in a scenario where the pressure as sensed at the location of the user's hip is e.g. 10, the pressure as sensed at the location of the user's shoulder is e.g. 5, while the pressure as sensed at the location of the user's leg is e.g. 2, the firmness sensing and adjusting layer, in particular the actuators provided in the layer, is configured to equalize the pressures by adjusting or decreasing the firmness at the location of the user's hip so that the pressure or supporting force at that location decreases to 5 from 10 and adjusting or increasing the firmness at the location of the user's leg so that the pressure or supporting force at that location increases to 5 from 2.

It is to be noted that the adjustment/equalizing of pressure does not necessarily operate to the extent of exact equalization. Instead, in some embodiments or scenarios the pressures may be adjusted less than equalization. Still referring to the scenario where the pressure at the location of hip is 10, the pressure at the location of shoulder is 5, while the pressure of the location of leg is 2, the firmness sensing and adjusting layer may equalize the pressure by decreasing the pressure of the location of hip to e.g. 6 or 7 while increasing the pressure of the location of leg to e.g. 3 or 4. On the other hand, it is possible to adjust the pressure beyond equalization in some cases. Still referring to the scenario where the pressure at the location of hip is 10, the pressure at the location of shoulder is 5, while the pressure of the location of leg is 2, the firmness sensing and adjusting layer may equalize the pressure by decreasing the pressure of the location of hip to e.g. 4 or 3 while increasing the pressure of the location of leg to e.g. 5 or 7.

In a further embodiment of the present disclosure, instead of or in addition to equalizing the pressures on an associated body supporting device such as mattress e.g. 100, a firmness sensing and adjusting layer e.g. 200 may be configured to make the user's spine straight or in a nature shape.

As an example, when a user is lying on her/his side on a mattress, the mattress supports the user's body and therefore pushes her/his backbone or spine up, which might cause her/his spine not straight, e.g. slightly upwards at some location(s). FIG. 5 schematically depicts a user lying on a mattress 100 with her/his spine being pushed upwards (as illustrated in solid line in FIG. 5) at her/his hip (i.e. at the location 160), in which case an associated firmness sensing and adjusting layer 200 (in particular the pressure sensors provided in the layer 200) senses a pressure map on the surface of the mattress 100 and determines based on the pressure map that there is a high pressure and a upward posture of spine at the location 160 where her/his hip touches the mattress 100 and then the layer 200 (and in particular actuator(s) provided in the layer 200 at the location(s) in actuator pattern corresponding to the location 160, it is to be noted that the location 160 may corresponding to more than one location in the pattern(s) e.g. matrix of the pressure sensors and/or of the actuators in the layer) decreases the firmness of the mattress 100 at that location 160 so as to moving the user's spine downwards (as illustrated in dotted line in FIG. 5) at that location 160, thereby making her/his spine straight.

It is also possible for a user to twist her/his spine when lying or sleeping or sitting or leaning on a body supporting device such as mattress. As an example, there might be a scenario where it is determined from a pressure map or some or all of the individual pressures sensed by the pressure sensors provided in a firmness sensing and adjusting layer that the user lying on an associated mattress twists her/his spine to left at a location L. In such scenario, the actuator(s) provided in the layer at location(s) corresponding to the left side of the location L may operate to increase the firmness of the mattress on left side of the location L, while the actuator(s) provided in the layer at location(s) corresponding to the right side of the location L may operate to decrease the firmness of the mattress on right side of the location L, thereby facilitate rolling (a part of) the user's body and thus the user's spine to right at the location L in order to make her/his spine straight.

Further, it is appreciated that it is possible to translate a user's body or body part(s) on a body supporting device such as mattress in a horizontal direction by the actuators making the pressure in or around the area, where the body or body part(s) is located, of the mattress higher on one side and lower on the other side. It is to be noted that the translation of a body or body part(s) in a horizontal direction may be realized in either of the following manners: 1) the difference in pressure on two sides of the area automatically force the body or body part(s) to be translated in a horizontal direction; 2) because of the difference in pressure on two sides of the area, the user autonomously adjusts or translates her/his body or body part(s) in a horizontal direction in order for a more comfortable position.

Alternatively, the translation of a body or body part(s) on a body supporting device such as mattress may also be realized by the actuators dynamically controlling the pressure around the area, where the body part is located, of the body supporting device such as mattress in such a way that the pressure forms a wavefront that moves in a horizontal direction and thus pushes or translates the body or body part(s) in the horizontal direction.

That is, with respect to the not straight or even twisted spine of a user lying or sitting or leaning on a body supporting device such as mattress, it is possible for a firmness sensing and adjusting layer, according to an embodiment of the present disclosure, associated with the body supporting device such as mattress to correct the user's spine back to straight and not twisted. In particular, the firmness sensing and adjusting layer first senses the pressure applied by the user's body or body part(s) on the associated body supporting device such as mattress, determines or deduces from the pressure map the locations of the user's body parts (e.g. shoulder, hip, feet, etc.) on the mattress and/or their postures, and then adjusts the firmness of some locations of the body support device such as mattress to move or roll the corresponding body parts on certain locations in order to correct the user's spine back to straight.

In use, a firmness sensing and adjusting layer may be configured to dynamically operate in response to the change in pressure map of or in response to the movement of a user lying or sitting or leaning on an associated body supporting device such as mattress e.g. during her/his sleep or sitting or leaning. As an example, when a user lying on a mattress rolls or turns her/his body over, the pressure sensors arranged in a pattern (e.g. matrix) in an associated firmness sensing and adjusting layer sense a pressure map and/or its change, and then the actuators arranged in the pattern or another pattern in the firmness sensing and adjusting layer control the firmness of the mattress at the corresponding locations accordingly.

As described above, an actuator provided at a location (e.g. La8 as illustrated in FIG. 2) in a firmness sensing and adjusting layer e.g. 200 is configured to adjust the firmness of an associated body supporting device such as mattress e.g. 100 at a corresponding location, i.e. at the location (e.g. L′a8 as illustrated in FIG. 3) on the surface of the associated body support device such as mattress that corresponds to the actuator's location (e.g. La8 as illustrated in FIG. 2).

It is understood that, the firmness or hardness of some resilient or elastic material such as foam or rubber may be changed (such as increased or decreased) by means of sound (e.g. ultrasound) energy. Therefore, in an embodiment of the present disclosure, an actuator may be implemented in the form of a (ultra)sound energy generator configurable to generates and injects (ultra)sound energy into the associated body supporting device such as mattress, in particular in a direction towards a localized location (e.g. L′a8 as illustrated in FIG. 3) on the surface of the body supporting device corresponding to the actuator's location (e.g. La8 as illustrated in FIG. 2), thereby increasing or decreasing the firmness of the body supporting device such as mattress at that corresponding location (e.g. L′a8 as illustrated in FIG. 3). It is to be noted that, it is not necessary for the (ultra)sound energy generated by an actuator to propagate to the surface of the body supporting device such as mattress, because even only a part (e.g. bottom half) of the body supporting device such as mattress in its thickness direction (e.g. vertical direction in case of mattress) at the actuator's location being made harder or softer by the actuator will result in the surface of the body supporting device such as mattress at that location harder or softer.

As an example, an actuator may be implemented as a (small) diaphragm configurable to generate and inject (ultra)sound energy into an associated body supporting device such as mattress, in particular in a direction towards a localized location on the surface of the body supporting device, in an embodiment of the present disclosure. That is, in or on a firmness sensing and adjusting layer a plurality of diaphragms are arranged in an appropriate pattern (e.g. in a matrix), which are each configurable to generate and inject (ultra)sound energy in a direction towards a corresponding localized location of the surface of the body supporting device such as mattress in order to increase or decrease the firmness of the body supporting device such as mattress at that localized location.

As a further example, an actuator may be implemented as a pin or needle configured to be inserted into an associated body supporting device such as mattress and configurable to vibrate to generate and propagate (ultra)sound energy into the body supporting device such as mattress, in particular in a direction towards a localized location on the surface of the body supporting device, in an embodiment of the present disclosure. That is, on a firmness sensing and adjusting layer a plurality of pins or needles are provided in an appropriate pattern (e.g. in a matrix), which are each configured to be inserted into an associated body supporting device such as mattress when the firmness sensing and adjusting layer is placed in association with (e.g. underneath) the body supporting device, and which are each configurable to vibrate in the body supporting device such as mattress to generate and propagate (ultra)sound energy in a direction towards a corresponding localized location of the surface of the body supporting device such as mattress in order to increase or decrease the firmness of the body supporting device such as mattress at that localized location.

Preferably, a (ultra)sound energy dampening and reflecting layer is further placed on a side of the firmness sensing and adjusting layer opposite to the body supporting device such as mattress (i.e. the firmness sensing and adjusting layer is sandwiched between the (ultra)sound energy dampening and reflecting layer and the body supporting device such as mattress, e.g. the (ultra)sound energy dampening and reflecting layer is placed underneath the firmness sensing and adjusting layer when the firmness sensing and adjusting layer is placed underneath the mattress), which is configured to dampen and/or reflect back to the associated body supporting device such as mattress the (ultra)sound energy that propagates to the (ultra)sound energy dampening and reflecting layer (i.e. in the direction opposite to the associated body supporting device such as mattress).

In a further embodiment of the present disclosure, magnetic energy may be employed to control the firmness of a body supporting device such as mattress. As an example, a plurality of actuators in the form of electromagnet are provided (e.g. printed) in a pattern (e.g. in the matrix 220 as illustrated in FIG. 2) in or on a firmness sensing and adjusting layer, while the same number of magnetic (e.g. ferromagnetic) components such as magnets (which may also be electromagnets), iron components, etc. are embedded in an associated body supporting device such as mattress in a corresponding pattern (e.g. in the same matrix as 220 illustrated in FIG. 2) in a plane parallel to the firmness sensing and adjusting layer. That is, a matrix 220 of electromagnets is provided (e.g. printed) in or on a firmness sensing and adjusting layer, while another matrix 220 is formed, in an associated body supporting device such as mattress in a plane parallel to the layer, of magnetic components like (electro)magnets or iron components embedded in the body supporting device such as mattress.

It is to be appreciated that, the correspondence between the pattern (e.g. same matrix as 220 illustrated in FIG. 2) of magnetic components such as (electro)magnets embedded in the body supporting device such as mattress and the pattern (e.g. matrix 220) of electromagnets in or on the firmness sensing and adjusting layer refers to a one-to-one correspondence between the magnetic components such as (electro)magnets in the body supporting device such as mattress and the electromagnets in the layer, that is, an electromagnet provided at a location (e.g. La8) in or on the layer corresponds to a corresponding magnetic component such as (electro)magnet embedded at a corresponding location in the body supporting device such as mattress.

In an example embodiment of the present disclosure, a plurality of (e.g. 10,000) electromagnets in the form of coil are printed in a matrix (e.g. a 100*100 matrix) on a firmness sensing and adjusting layer. Also the same number (e.g. 10,000) of magnetic components such as (electro)magnets are embedded into an associated body supporting device such as mattress (e.g. a foam mattress), forming a corresponding matrix (e.g. a 100*100 matrix) in a plane parallel to the layer, in which the electromagnets provided in the firmness sensing and adjusting layer and the magnetic components such as (electro)magnets embedded in the associated body supporting device such as mattress have a one-to-one correspondence and the locations of the magnetic components such as (electro)magnets in the body supporting device such as mattress and the locations of the electromagnets in the layer have a one-to-one correspondence.

Since the magnetic components such as (electro)magnets embedded in a body supporting device such as mattress are arranged in a pattern (e.g. matrix) and the electromagnets provided in an associated firmness sensing and adjusting layer are arranged in a corresponding pattern, it is possible to control individually the attraction/repulsion between any electromagnet provided in the layer and its corresponding magnetic components such as (electro)magnet embedded in the body supporting device such as mattress by operating that electromagnet in the layer and/or its corresponding magnetic components such as (electro)magnet in the body supporting device such as mattress, thereby control or adjust the firmness of the body supporting device such as mattress at the corresponding location on the surface of the body supporting device.

In particular, when an electromagnet provided in a firmness sensing and adjusting layer at a location e.g. Lg28 and its corresponding magnetic components such as (electro)magnet embedded in a body supporting device such as mattress are controlled to attract each other, the attraction moves or pull that magnetic components such as (electro)magnet in the body supporting device such as mattress towards the firmness sensing and adjusting layer, with which movement that magnetic components such as (electro)magnet in the body supporting device such as mattress compresses the resilient material of the body supporting device between that magnetic components such as (electro)magnet and the layer and decompresses the resilient material of the body supporting device on its opposite side, thereby making the surface of the body supporting device opposite to the layer softer at a corresponding location e.g. L′g28. On the other hand, when an electromagnet provided in a firmness sensing and adjusting layer at a location e.g. Lg15 and its corresponding magnetic components such as (electro)magnet embedded in a body supporting device such as mattress are controlled to repel each other, the repulsion moves or pushes that magnetic components such as (electro)magnet in the body supporting device such as mattress away from the firmness sensing and adjusting layer, with which movement that magnetic components such as (electro)magnet in the body supporting device such as mattress decompresses the resilient material of the body supporting device between that magnetic components such as (electro)magnet and the layer and compresses the resilient material of the body supporting device on its opposite side, thereby making the surface of the body supporting device opposite to the layer harder at a corresponding location e.g. L′g15. In such way, it is possible to individually control or adjust the firmness of a body supporting device such as mattress at a localized location by using the attraction/repulsion between an electromagnet in a firmness adjusting layer at a corresponding location and a corresponding magnetic components such as (electro)magnet in the body supporting device such as mattress.

It is to be appreciated that, when the magnetic components embedded in a body supporting device such as mattress are implemented as electromagnets, either or both of 1) the electromagnets in the layer and 2) the electromagnets in the body supporting device such as mattress can be manipulated in order to control their attraction/repulsions, thereby controlling the firmness of the surface of the body supporting device. On the other hand, when the magnetic components embedded in a body supporting device such as mattress are implemented as magnets or iron components, rather than electromagnets, only the electromagnets in the layer can be manipulated to control their attraction/repulsions to the respective magnetic components embedded in the body supporting device such as mattress thereby controlling the firmness of the surface of the body supporting device.

It is to be noted that, there exits the possibility that a magnetic component might, when being moved (e.g. pulled or pushed) under attraction or repulsion, slip away from or even damage the resilient material around or above or underneath it, and thus cannot efficiently move (e.g. pull or push), and thereby compress or decompress the resilient material around or above or underneath it.

Therefore, in order to improve the compression/decompression of the resilient material of the body supporting device caused by the attraction/repulsion between an electromagnet in a firmness adjusting layer and a corresponding magnetic component such as (electro)magnet in an associated body supporting device such as mattress and/or in order to avoid the potential damage to the resilient material in the body supporting device such as mattress by the movement of the magnetic component such as (electro)magnet in the body supporting device such as mattress, the magnetic component such as (electro)magnet embedded in the body supporting device such as mattress may be of a flat configuration, i.e. with a height substantially smaller than its length and width, according to an embodiment of the present disclosure. With such a flat configuration, a magnetic component such as (electro)magnet embedded in a body supporting device such as mattress will have a surface area sufficient to move (e.g. pull or push) the resilient material of the body supporting device on either or both side(s) of the (electro)magnet, thereby efficiently control or adjust the firmness of the body supporting device such as mattress at the corresponding localized location.

By way of example, when a magnetic component such as (electro)magnet in a body supporting device such as mattress moves e.g. downwards under attraction to a corresponding electromagnet in an associated firmness sensing and adjusting layer, the resilient material above that magnetic component such as (electro)magnet is decompressed, thereby making the surface of the body supporting device such as mattress at the corresponding localized location less hard, while the resilient material underneath that magnetic component such as (electro)magnet is compressed. On the other hand, when a magnetic component such as (electro)magnet in a body supporting device such as mattress moves upwards under repulsion from a corresponding electromagnet in an associated firmness sensing and adjusting layer, the resilient material above that magnetic component such as (electro)magnet is compressed, thereby making the surface of the body supporting device such as mattress at the corresponding localized location harder, while the resilient material under that magnetic component such as (electro)magnet is decompressed.

In order to further improve the compression/decompression of the resilient material of a body supporting device such as mattress caused by the attraction/repulsion between an electromagnet in a firmness adjusting layer and a corresponding magnetic component such as (electro)magnet in an associated body supporting device such as mattress, an amount of adhesive such as epoxy may be injected to the location of the magnetic component such as (electro)magnet in the body supporting device such as mattress that adheres to the magnetic component such as (electro)magnet and form a large surface area to facilitate the efficient movement of the resilient material.

Alternatively, according to an embodiment of the present disclosure the magnetic component such as (electro)magnet embedded in a body supporting device such as mattress may be of an elongate configuration (i.e. with a height substantially larger than its length and width) and be provided with adhesive such as epoxy or glue around it, especially on its side. With the adhesive being provided around it, especially on its side, a magnetic component such as (electro)magnet embedded in a body supporting device such as mattress, even though with an elongate configuration, will be provided with a surface sufficient to move (e.g. pull or push) the resilient material of the body supporting device surrounding the magnetic component such as (electro)magnet, thereby efficiently control or adjust the firmness of the body supporting device such as mattress at the corresponding localized location.

It is to be appreciated that, in an embodiment of the present disclosure, instead of being constructed as individual or separated components or pieces e.g. individual (electro)magnets or iron components, the magnetic components such as (electro)magnets or iron components embedded in a body supporting device may be implemented in the form of a whole sheet or layer of flexible magnetic material like ferromagnetic material in rubber, in which a electromagnet provided in an associated firmness adjusting layer pulls or pushes a corresponding portion (e.g. the portion directly above or below the electromagnet) of the flexible magnetic material layer under attraction or repulsion therebetween, thereby controlling or adjusting the firmness of the surface of the body supporting device at a corresponding location.

In another embodiment of the present disclosure, the magnetic components embedded in a body supporting device may be implemented in the form of a whole sheet or layer of fabric or textile woven with the magnetic components in it or a whole sheet of layer of resilient material embedded with magnetic components, in which when a magnetic component is moved (e.g. pulled or pushed) under attraction or repulsion, the layer, or the fabric or textile or resilient material in the layer causes its portion around that magnetic component to move correspondingly, thereby adjusting the firmness of a larger portion of the surface of the associated body supporting device.

It is appreciated that, the embedding of the magnetic component such as (electro)magnet in a body supporting device such as mattress and/or the provision (e.g. injection) of adhesive around the magnetic component such as (electro)magnet may be performed during or after the manufacturing of the body supporting device such as mattress.

In an embodiment of the present disclosure, a plurality of magnetic component such as (electro)magnets are embedded in a body supporting device such as mattress during the manufacturing of the body supporting device such as mattress. In particular, a body supporting device such as mattress may be constructed with a multi-layer configuration, i.e. is consisted of resilient material layer(s) and magnetic component (e.g. (electro)magnet or iron component) layer(s) in which a plurality of magnetic component such as (electro)magnets are provided that are each configurable to move upwards and/or downwards under attraction/repulsion to adjust the firmness on the surface of the body supporting device such as mattress at a corresponding localized location.

As an example, a body supporting device such as mattress is consisted of a upper resilient material layer, a lower resilient material layer, and a middle magnetic component (e.g. (electro)magnet) layer sandwiched between the upper and the lower resilient material layers, in an embodiment of the present disclosure. A plurality of magnetic components (e.g. (electro)magnets) are provided in the middle (electro) magnet layer in a pattern (e.g. a matrix) that cooperate with the same number of electromagnets provided in an associated firmness adjusting layer in such a way that the movement of a magnetic component (e.g. (electro)magnet) decompresses/compresses the resilient material on one or both of its side (e.g. above and/or underneath it), thereby adjusting the firmness on the surface of the body supporting device such as mattress at a corresponding localized location.

With respect to an electromagnet being embedded in a body supporting device as magnetic component, there are a variety of methods to provide or embed it in the body supporting device such as mattress. As an example, a sewing machine may be employed, which introduces a wire into a body supporting device such as mattress at a location, coils the wire in the body supporting device such as mattress at that location, and retreats the wire out of the body supporting device such as mattress, and then repeats the above steps at other locations by using the same wire, thereby embedding a pattern (e.g. matrix) of electromagnets into the body supporting device such as mattress.

As another example, two needles may be employed to embed an electromagnet into a body supporting device such as mattress, in which one smaller needle is provided inside the other needle. The bigger needle is inserted together with the smaller needle and a wire into the body supporting device such as mattress at a localized location, the smaller needle coils the wire in the body supporting device such as mattress at that location, and then the bigger needle is pulled out of the body supporting device such as mattress together with the smaller needle and the wire, leaving a coil (i.e. electromagnet) in the body supporting device such as mattress at that location. By repeating the above steps at different locations in the body supporting device such as mattress, a pattern (e.g. matrix) of electromagnets is embedded into the body supporting device such as mattress.

With respect to a magnet or iron component being embedded in a body supporting device as magnetic component, the magnet or iron component may be inserted or shot into a body supporting device such as mattress at a localized location with a needle or a shooting gun.

Although the embodiments above have been described in considerable detail, numerous variations and modifications will become apparent to those skilled in the art once the above disclosure is fully appreciated. It is intended that the following claims be interpreted to embrace all such variations and modifications.

The invention claimed is:

1. A body supporting system comprising:
a body supporting device configured to support at least part of a body;
a pressure sensing layer comprising a plurality of pressure sensors arranged in a sensor pattern, the plurality of pressure sensors being each configured to sense pressure on the surface of the body supporting device at a corresponding sensing location; and
a firmness adjusting layer comprising a plurality of actuators arranged in an actuator pattern, the plurality of actuators are each configured to control the firmness of the surface of the body supporting device at a corresponding adjusting location based on some or all of the pressures sensed by the plurality of pressure sensors.

2. The body supporting system as claimed in claim 1, wherein the actuators comprises sound generators configurable to generate and propagate sound energy in a direction towards their respective adjusting locations on the surface of the body supporting device.

3. The body supporting system as claimed in claim 2, wherein the sound generators are in the form of diaphragm.

4. The body supporting system as claimed in claim 2, wherein the sound generators are in the form of pin or needle, and are configured to be inserted into the body supporting device and configurable to vibrate to generate and propagate sound energy.

5. The body supporting system as claimed in claim 1, wherein the actuators comprises electromagnets, and the same number of magnetic components as the actuators are embedded in the body supporting device in a plane parallel to the surface of the body supporting device in a pattern corresponding to the actuator pattern.

6. The body supporting system as claimed in claim 5, wherein the magnetic components embedded in the body supporting device is of a flat configuration.

7. The body supporting system as claimed in claim 5, wherein the magnetic components embedded in the body supporting device is of an elongate configuration and is provided with adhesive around it.

8. The body supporting system as claimed in claim 5, wherein the magnetic components embedded in the body supporting device comprises electromagnets.

9. The body supporting system as claimed in claim 8, wherein the electromagnets are embedded in the body supporting device by means of a sewing machine.

10. The body supporting system as claimed in claim 8, wherein the electromagnets are embedded in the body supporting device by means of two needles, in which a smaller needle is provided inside the other needle that is configured to be inserted together with the smaller needle and a wire into the body supporting device and to be pulled out of the body supporting device together with the smaller needle and the wire after the smaller needle coils the wire in the body supporting device to create an electromagnet.

11. The body supporting system as claimed in claim 5, wherein the magnetic components embedded in the body supporting device comprises magnets or iron components.

12. The body supporting system as claimed in claim 5, wherein the magnetic components embedded in the body supporting device are implemented as a whole sheet or layer of flexible magnetic material.

13. The body supporting system as claimed in claim 5, wherein the magnetic components embedded in the body supporting device are implemented as a whole sheet or layer of fabric woven with magnetic material or of resilient material embedded with magnetic material.

14. The body supporting system as claimed in claim 1, wherein the firmness adjusting layer is configured to equalize the pressures applied by the at least part of the body on the surface of the body supporting device, or to keep the spine of the body straight.

15. The body supporting system as claimed in claim 1, wherein the pressure sensing layer and the firmness adjusting layer are placed underneath, on top of, or in middle of the mattress.

16. The body supporting system as claimed in claim 1, wherein the pressure sensing layer and the firmness adjusting layer are integrated to each other.

17. The body supporting system as claimed in claim 13, wherein the sensor pattern is the same as or different from the actuator pattern.
